(19) United States
(12) Patent Application Publication
(10) Pub. No.: US 2007/0290860 A1
(43) Pub. Date: Dec. 20, 2007

(54) Apparatus, systems, and methods for tracking moving objects tagged with wireless tags

(76) Inventors: Michael T. Lucas, Calabasas, CA (US); Matt D. Truong, Boyds, MD (US)

Correspondence Address: NATH & ASSOCIATES, 112 South West Street, Alexandria, VA, 22314, US

(21) Appl. No.: 11/797,220

(22) Filed: May 1, 2007

Related U.S. Application Data
(60) Provisional application No. 60/796,140, filed on May 1, 2006.

(51) Int. Cl. G08B 13/14

(52) U.S. Cl. 340/572.7

(57) ABSTRACT

The inventive subject matter relates to a novel wireless tracking apparatus, and systems methods for using the apparatus for tracking moving objects tagged with wireless tags. In particular, the wireless tags are preferably RFID tags and the apparatus comprises at least two RFID readers, each reader comprising an antenna and a transceiver, wherein the antenna are oriented at an angle to each other so that the signal transmissions of adjoining readers do not overlap.

### BACKGROUND OF THE INVENTIVE SUBJECT MATTER

1. Field of Inventive Subject Matter

The inventive subject matter relates to a novel wireless tracking apparatus, systems, and methods for using the apparatus for tracking moving objects tagged with wireless tags. In particular, the wireless tags are preferably RFID tags and the apparatus comprises at least two RFID readers, each reader comprising an antenna and a transceiver, wherein the antenna are oriented at an angle to each other so that the signal transmissions of adjoining readers does not overlap.

2. Background

For inventory management systems and other object tracking systems, there is a growing need for the ability to accurately and economically track a wide variety of inventory items and other objects. This includes tracking objects passing a fixed location, such as points of ingress and egress from factories, distribution centers, retail stores, and the like. Loading docks are an example of such a fixed location, where there is a need to be able to accurately and economically track a large number of items, both entering and leaving the facility.

Radio frequency identification systems usually include at least one radio frequency antenna and a reader. During a typical usage, the RFID system transmits a radio frequency at a certain frequency or within a certain frequency range towards an RFID tag. An RFID tag typically includes a chip (often smaller than a pin head) and an antenna portion. The energy in the radio waves transmitted onto the tag may be used to “excite” or energize the tag. The chip is often programmed with a globally unique identification (GUID) number, and upon exciting the tag, the GUID number is emitted from the tag in the form of radio waves. A receiving antenna of the RFID system receives the radio waves emitted from the tag, and a reader device extracts the GUID number from the signal in the tag's emitted radio waves. This GUID number may then be correlated to a product or item in a database. The transmitting antenna may be separate from the receiving antenna (e.g., pitch-catch configuration), or they may be one and the same (i.e., transmit and receive with same antenna).

RFID systems may have a variety of forms and configurations for different applications, such as: a hand held device (e.g., wand), a free standing structure (e.g., theft detection devices in retail stores), a fixed structure attached to or extending from a building (e.g., warehouse inventory tracking), or a toll tag reader structure above a toll road, for example.

Some current RFID systems utilize panels directed at approximately right-angles to the flow of traffic, supplemented by optical light systems such as a “electric eye” for detecting when an object passes between the sending and receiving units of such a detector system. Breaking the circuit thus indicates the presence of an object in the beam path.

However, with such a system, it is often difficult or impossible to detect objects with RFID tags that are not in the signal path of the RFID panels. Thus, tags located on the “sides” of objects, “sides” being a relative term indicating the part nearest to a detector, are readily detected. On the other hand, those tags which are affixed to other locations on an object, such as might be found on top, on the front, or on the back of an object, however, are not so readily detected, and may be missed by a scan oriented at about a right angle to the direction of travel of the object, according to the current prior art systems and methods.

Thus, current systems do not detect all, nor indeed sometimes even a substantial number, of RFID tags affixed to a group of objects, such as might be found in a package of items or a pallet of boxes or packages. Further, current systems cannot detect direction of travel of tagged objects with the RFID equipment, instead requiring a distinct optical or other system with multiple detectors in order to determine direction of travel.

Unfortunately, previous attempts at solving these problems and creating a direction tracking system have failed to provide accuracy and economy for such a system. For example, previous systems have relied upon complex systems with angle calculators and distance calculators to determine relative location over time, and multiple detectors with overlapping communication ranges to maintain contact with a tag. The cost and accuracy limitations of these previous methods have prevented their adoption in applications that needed to provide the ability to track large numbers of objects at a relatively low per-unit cost.

Accordingly, it is an object of the inventive subject matter to provide an apparatus providing an improved system and an improved method for tracking moving objects. Other desirable features and characteristics of the present invention will become apparent from the subsequent detailed description and the appended claims, taken in conjunction with the accompanying drawings and the foregoing discussions of the technical field and background of the invention.

### SUMMARY OF THE INVENTIVE SUBJECT MATTER

The inventive subject matter relates to an apparatus, to object tracking systems, and to methods for tracking objects. In one embodiment, the apparatus and system include a plurality of radio frequency identification (“RFID”) readers in a tower structure, mounted in an orientation in which the detector fields do not overlap and do target different sides of an object. An RFID tag is affixed with the object that is to be located. The RFID reader transmits signals to the RFID tag and receives backscatter-modulated radio frequency (“RF”) signals from the RFID tag at one or more RFID antennas. From those received signals, system software determines, over a period of time, which antenna(s) is/are detecting a particular tag, thus determining the direction of movement of the object(s) by comparing the location of the detectors with the time(s) of detection.

The RFID readers are optionally, and preferably, configured in either (1) a “triangle” apparatus, comprising two antenna located parallel to the equal sides of an apparatus which is in the cross-sectional shape, viewed from above, of an isosceles triangle, preferably an isosceles right triangle; or (2) a “diamond” apparatus, comprising four antenna located parallel to the four sides of an apparatus which is in the cross-sectional shape, viewed from above, of a diamond, with four equal sides forming two inner obtuse angles and two inner acute angles, or four right angles.

For aesthetics and to protect the RFID reader panels from damage, the reader panels are preferably covered by an RF-transparent material, such as plastic, plexiglass, or glass, selected for appropriate properties based on the RF frequency of the RFID system.

Importantly, the inventive apparatus is smaller than existing systems, requires fewer antenna, and requires less floor space, resulting in a savings in cost, reduced complexity, and reduced damage from minimizing exposure to equipment and traffic which might produce damage.

Thus, the inventive subject relates to a portal apparatus for tracking a moving object tagged with an RFID tag having a GUID or other identifying number, comprising the following elements operably connected:

(i) a generally column-shaped structure comprising a base and a frame supported by the base, the frame extending along a generally vertical axis of the structure,

wherein the column-shaped structure has three sides and, as viewed from above or below, is substantially in the shape of an isosceles right triangle which defines the three sides of the column-shaped structure: a hypotenuse side opposite the right angle and first and second equal-length leg sides;

(ii) a plurality of RFID antennas which are oriented to read outwardly, are supported by and attached to the frame, are mounted substantially parallel to the first and second equal-length leg sides of the column-shaped structure, and are oriented to read substantially perpendicular to each other in relation to the vertical axis; and

(iii) a reader which is capable of detecting and outputting data received from the plurality of RFID antennas, said data comprising the tag GUID or other identifying number detected and which of the plurality of RFID antennas detected the tag.

Further, the inventive subject relates to a portal system for tracking a moving object tagged with an RFID tag having a GUID or other identifying number, comprising the following elements operably connected:

(i) at least two generally column-shaped structures, each comprising a base and a frame supported by the base, the frame extending along a generally vertical axis of the structure,

wherein each column-shaped structure has three sides and, as viewed from above or below, is substantially in the shape of an isosceles right triangle which defines the three sides of the column-shaped structure: a hypotenuse side opposite the right angle and first and second equal-length leg sides;

(ii) a plurality of RFID antennas which are oriented to read outwardly, are supported by and attached to the frame, are mounted substantially parallel to the first and second equal-length leg sides of each column-shaped structure, and are oriented to read substantially perpendicular to each other in relation to the vertical axis,

wherein the at least two generally column-shaped structures are situated on opposite sides of the portal, and are oriented so that each RFID antenna is oriented to read at an angle of about 45 degrees to a direction of travel through the portal;

(iii) a reader which is capable of detecting and outputting data received from the plurality of RFID antennas, said data comprising (a) the tag GUID or other identifying number detected and (b) which of the plurality of RFID antenna(s) detected the tag;

(iv) a timer which is capable of recording and outputting a time of detection of a tag; and

(v) a processor and memory, which is capable of receiving, storing and comparing the output antenna, tag number, and time data detected, and determining a relative direction of travel for a tagged object, in relation to the portal.

Additionally, the inventive subject relates to a method for tracking an object, tagged with an RFID tag, passing through a portal, comprising the steps of:

(a) at a first time point, recording, date stamping, and storing in a database data received from a plurality of RFID antennas, said data comprising (i) a tag GUID or other identifying number detected and (ii) which of the plurality of RFID antenna(s) detected the tag;

(b) at a second time point, recording, date stamping, and storing in a database data received from a plurality of RFID antennas, said data comprising (i) a tag GUID or other identifying number detected and (ii) which of the plurality of RFID antenna(s) detected the tag;

(c) comparing the data detected at the first time point and the second time point; and

(d) and determining a relative direction of travel for a tagged object, in relation to the portal.

### BRIEF DESCRIPTION OF THE DRAWINGS

FIG. 1 is a drawing which depicts an overhead view of two “triangle” readers placed on opposite sides of a doorway. Dashed lines depict approximate detection angles and ranges of RFID panels mounted parallel to the equal sides of the isosceles triangle shape of each reader.

FIG. 2 is a drawing which depicts an overhead view of one “diamond” reader and two “triangle” readers in relation to two adjoining doorways. Dashed lines depict approximate detection angles and ranges of RFID reader panels mounted parallel to the equal sides of the isosceles triangle shape of each “triangle” reader, and panels mounted parallel to the four sides of the “diamond” reader.

FIG. 3 is a pair of drawings which depict a comparison between current and inventive systems. FIG. 3A depicts an exemplary present RFID method and system for detecting moving tagged objects. FIG. 3B depicts an exemplary inventive RFID method and system for detecting moving tagged objects.

FIG. 4 is a series of three perspective drawing which depict a “diamond” reader tower. FIG. 4A is a drawing which depicts a “diamond” reader tower with the RFID antennas in place, but without the side cover panels. FIG. 4B is a drawing which depicts a “diamond” reader tower with the RFID antennas and the side cover panels in place. FIG. 4C is a drawing which depicts a “diamond” reader tower with the RFID antennas, the side cover panels, and the top removed.

FIG. 5 is a pair of side elevation drawings which depict a “diamond” reader tower. FIG. 5A is a drawing which depicts a first side of a “diamond” reader tower. FIG. 5B is a drawing which depicts a second side of a “diamond” reader tower.

FIG. 6 is a pair of perspective drawing which depict the top and bottom panels of a “diamond” reader tower. FIG. 6A is a drawing which depicts the top panel of a “diamond” reader tower. FIG. 6B is a drawing which depicts the bottom panel of a “diamond” reader tower.

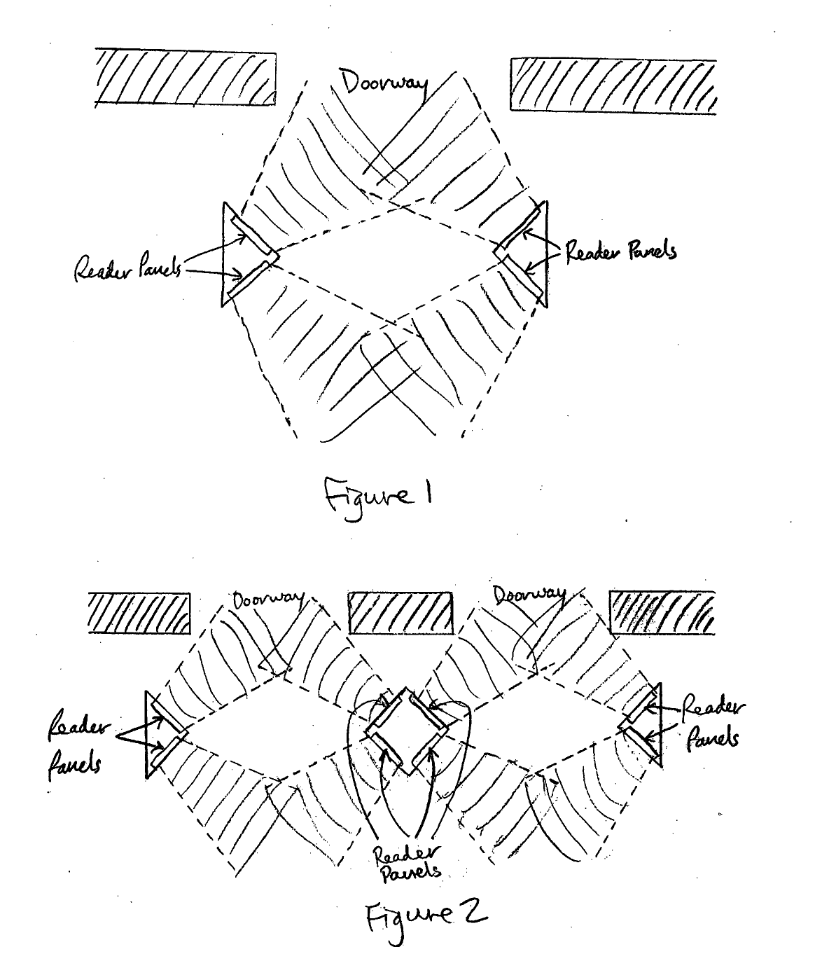

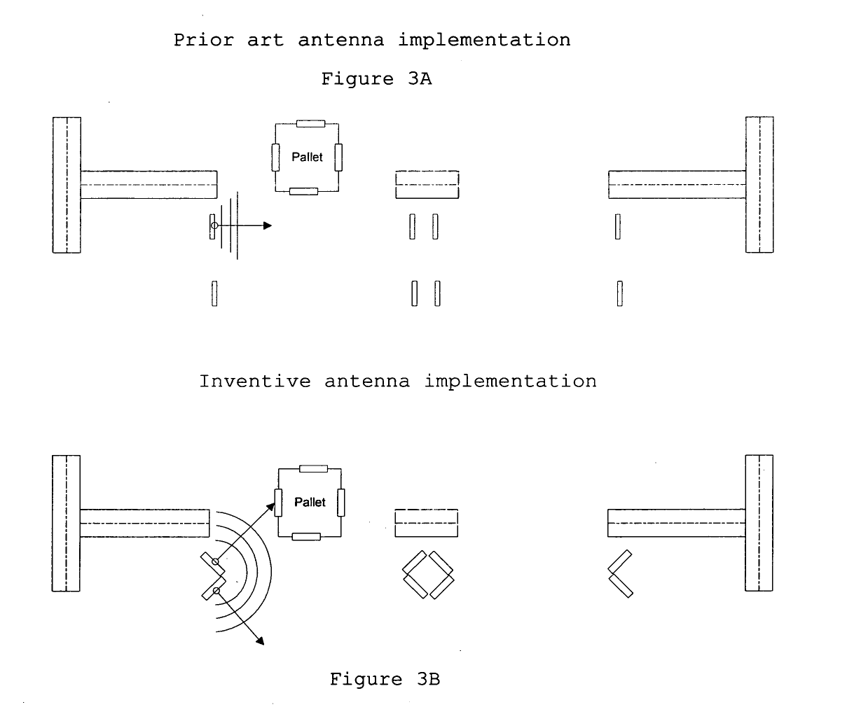

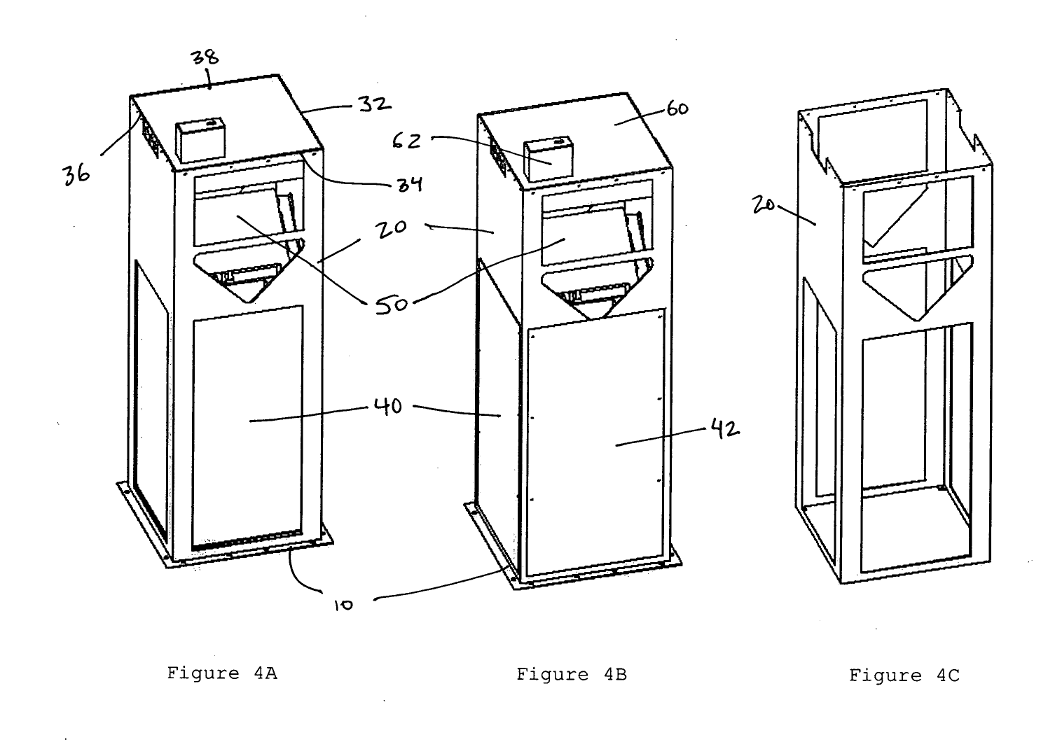

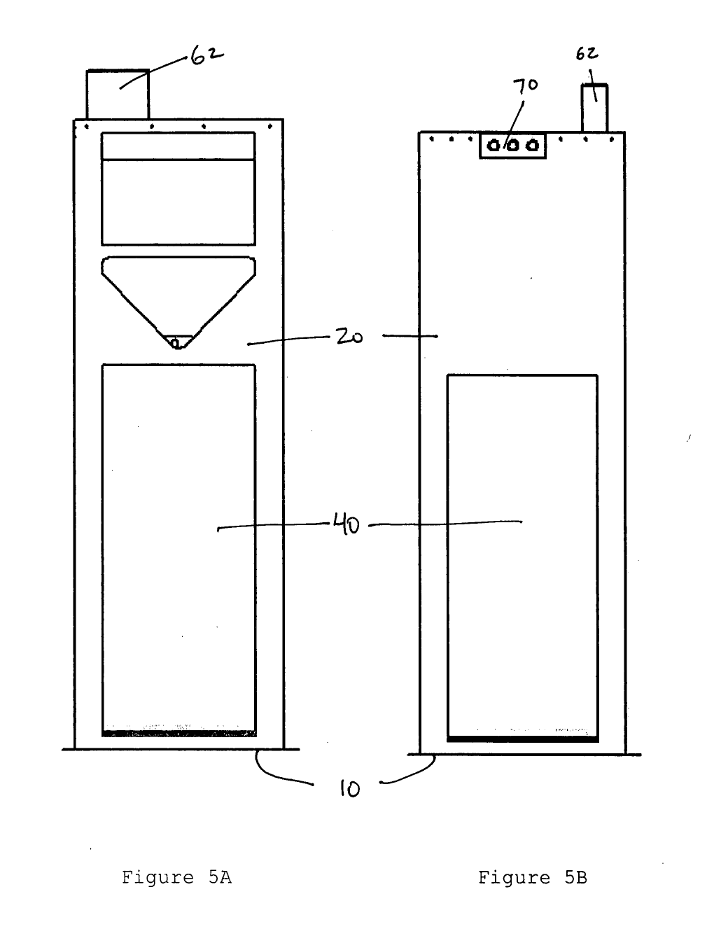

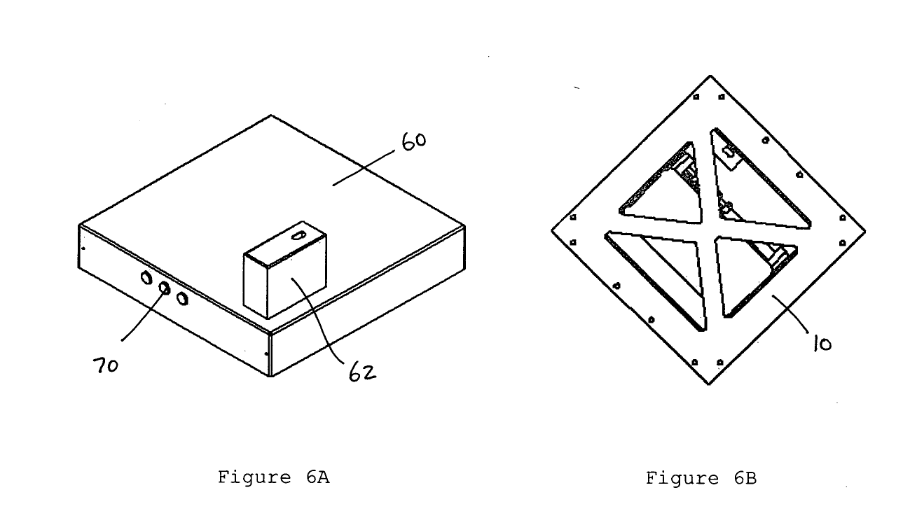

### DETAILED DESCRIPTION OF THE INVENTIVE SUBJECT MATTER

The inventive subject matter relates to an apparatus, to object tracking systems, and to methods for tracking objects.

The “triangle” and “diamond” reader designs will most preferably have two sets of antennas facing each direction of traffic flow at about a 45 degrees angle. By having multiple antennas, the inventive reader designs provide redundancy into the portal. In other words, the read field is larger. Thus, the read rate increases. Tags that are placed on the front or the back of the pallets or boxes can be more easily detected.

Further, as described in greater detail below, when one antenna reads the tags before the other, the inventive system can determine the direction of tag movement. To set up a system to determine directionality of product or pallets today, the current implementation is to add multiple portals separated by some distance in, for example, a store or warehouse. Thus, the inventive apparatus and systems can be implemented at a lower cost and using less floor space. Having fewer portals in the warehouse means fewer readers. Having fewer readers means less opportunity for RF interference. Thus, the inventive apparatus and systems provide at least two significant advantages over the prior art systems: they are simple to implement and more cost effective.

### Inventive Apparatus

The inventive subject matter relates to an apparatus for tracking a moving object, comprising:

(i) a plurality of radio frequency antennas;

(ii) a generally column-shaped structure supporting the antennas therein, the column-shaped structure comprising a base, a frame attached to and supported by the base, the frame extending along a generally vertical axis of the structure, and a plurality of RF-transparent side cover panels coupled to the frame,

wherein each antenna is supported by and attached to the frame and covered by a cover panel, and

wherein column-shaped structure is either a triangle apparatus or a diamond apparatus; and

(iii) a device having a processor and memory, which is capable of (a) storing data relating to the identity of the panel(s) which detect an RFID tag at a first time point and a second time point, (b) comparing stored location information for the panel(s) detected at the first time point and the second time point, and (c) determining a direction of the detected RFID tag from the stored location information.

In a preferred embodiment, the number of radio frequency antennas per side panel is one or two. In a most preferred embodiment, the number of radio frequency antennas per side panel is two.

In another embodiment, the column-shaped structure has adjoining side panels having radio frequency antennas oriented to each other at an angle between about 60 and about 120 degrees. In a more preferred embodiment, the column-shaped structure has adjoining side panels having radio frequency antennas oriented to each other at an angle between about 75 and about 105 degrees. In a most preferred embodiment, the column-shaped structure has adjoining side panels having radio frequency antennas oriented to each other at an angle between of about 90 degrees.

In an alternate embodiment, the apparatus comprises a plurality of column-shaped structures operably linked by a single comparator device. In a more preferred embodiment, the number of column-shaped structures per functional unit is two.

Thus, the inventive subject relates to a portal apparatus for tracking a moving object tagged with an RFID tag having a GUID or other identifying number, comprising the following elements operably connected:

(i) a generally column-shaped structure comprising a base 10 and a frame 20 supported by the base, the frame extending along a generally vertical axis of the structure,

wherein the column-shaped structure has three sides and, as viewed from above, is substantially in the shape of an isosceles right triangle which defines the three sides of the column-shaped structure: a hypotenuse side opposite the right angle 30 and first and second equal-length leg sides, 32 and 34;

(ii) a plurality of RFID antennas 40 which are oriented to read outwardly, are supported by and attached to the frame, are mounted substantially parallel to the first and second equal-length leg sides of the column-shaped structure, and are oriented to read substantially perpendicular to each other in relation to the vertical axis; and

(iii) a reader 50 which is capable of detecting and outputting data received from the plurality of RFID antennas, said data comprising the tag GUID or other identifying number detected and which of the plurality of RFID antennas detected the tag.

In one aspect of the inventive subject matter, the apparatus further comprises a plurality of RF-transparent side cover panels 42 coupled to the frame and covering the RFID antennas.

In another aspect of the inventive subject matter, the apparatus further comprises a timer, and wherein the apparatus is additionally capable of detecting and outputting a time of detection of a tag.

In a further aspect of the inventive subject matter, the apparatus additionally comprises a processor and memory, which is capable of receiving, storing and comparing the output antenna, tag number, and time data detected, and determining a relative direction of travel for a tagged object, in relation to the portal.

In yet another aspect of the inventive subject matter, the column-shaped structure additionally comprises a fourth side and, as viewed from above or below, is substantially in the shape of a diamond which defines four substantially equal sides 32, 34, 36, and 38 of the column-shaped structure, and

wherein the plurality of RFID antennas are mounted substantially parallel to each of the four sides of the column-shaped structure, and are oriented to read outwardly.

The column-shaped structure optionally, and preferably, has a top cover 60 which houses additional electronics and a battery power supply 62. Other features of the invention include a series of status lights 70, such as LEDs.

### Inventive Systems

The inventive subject matter also relates to a system for tracking objects, comprising:

(i) a plurality of radio frequency antennas;

(ii) a generally column-shaped structure supporting the antennas therein, the column-shaped structure comprising a base, a frame attached to and supported by the base, the frame extending along a generally vertical axis of the structure, and a plurality of RF-transparent side cover panels coupled to the frame,

wherein each antenna is supported by and attached to the frame and covered by a cover panel, and

wherein column-shaped structure is either a triangle apparatus or a diamond apparatus; and

(iii) a comparator device having a processor and memory, which is capable of (a) storing data relating to the identity of the panel(s) which detect an RFID tag at a first time point and a second time point, (b) comparing stored location information for the panel(s) detected at the first time point and the second time point, and (c) determining a direction of the detected RFID tag from the stored location information.

In a preferred embodiment, the number of radio frequency antennas per side panel is one or two. In a most preferred embodiment, the number of radio frequency antennas per side panel is two.

In another embodiment, the column-shaped structure has adjoining side panels having radio frequency antennas oriented to each other at an angle between about 60 and about 120 degrees. In a more preferred embodiment, the column-shaped structure has adjoining side panels having radio frequency antennas oriented to each other at an angle between about 75 and about 105 degrees. In a most preferred embodiment, the column-shaped structure has adjoining side panels having radio frequency antennas oriented to each other at an angle between of about 90 degrees.

In an alternate embodiment, the apparatus comprises a plurality of column-shaped structures operably linked by a single comparator device. In a more preferred embodiment, the number of column-shaped structures per functional unit is two.

Further, the inventive subject relates to a portal system for tracking a moving object tagged with an RFID tag having a GUID or other identifying number, comprising the following elements operably connected:

(i) at least two generally column-shaped structures, each comprising a base and a frame supported by the base, the frame extending along a generally vertical axis of the structure,

wherein each column-shaped structure has three sides and, as viewed from above or below, is substantially in the shape of an isosceles right triangle which defines the three sides of the column-shaped structure: a hypotenuse side opposite the right angle and first and second equal-length leg sides;

(ii) a plurality of RFID antennas which are oriented to read outwardly, are supported by and attached to the frame, are mounted substantially parallel to the first and second equal-length leg sides of each column-shaped structure, and are oriented to read substantially perpendicular to each other in relation to the vertical axis,

wherein the at least two generally column-shaped structures are situated on opposite sides of the portal, and are oriented so that each RFID antenna is oriented to read at an angle of about 45 degrees to a direction of travel through the portal;

(iii) a reader which is capable of detecting and outputting data received from the plurality of RFID antennas, said data comprising (a) the tag GUID or other identifying number detected and (b) which of the plurality of RFID antenna(s) detected the tag;

(iv) a timer which is capable of recording and outputting a time of detection of a tag; and

(v) a processor and memory, which is capable of receiving, storing and comparing the output antenna, tag number, and time data detected, and determining a relative direction of travel for a tagged object, in relation to the portal.

In one aspect of the inventive subject matter, the system further comprises a plurality of RF-transparent side cover panels coupled to the frame and covering the RFID antennas.

In another aspect of the inventive subject matter, one or more of the column-shaped structures additionally comprises a fourth side and, as viewed from above or below, is substantially diamond-shaped and defines four substantially equal sides of the column-shaped structure,

wherein the plurality of RFID antennas are mounted substantially parallel to each of the four sides of the column-shaped structure, are oriented to read substantially perpendicular to each other in relation to the vertical axis, and are oriented to read outwardly, and

wherein such diamond-shaped structure(s) are situated between two portals and detect RFID tags in motion through each portal.

### Inventive Methods

The inventive subject matter relates to a method for tracking objects, utilizing a system for detecting wireless tags having at least two RF reader units arranged in a non-overlapping orientation, comprising the steps of:

(i) detecting and storing data relating to the identity of RFID antenna panel(s) which detect an RFID tag at a first time point and a second time point;

(ii) comparing stored location information for the detecting panel(s) at the first time point and the second time point; and

(iii) determining a direction of the detected RFID tag from the stored location information.

Additionally, the inventive subject relates to a method for tracking an object, tagged with an RFID tag, passing through a portal, comprising the steps of:

(a) at a first time point, recording, date stamping, and storing in a database data received from a plurality of RFID antennas, said data comprising (i) a tag GUID or other identifying number detected and (ii) which of the plurality of RFID antenna(s) detected the tag;

(b) at a second time point, recording, date stamping, and storing in a database data received from a plurality of RFID antennas, said data comprising (i) a tag GUID or other identifying number detected and (ii) which of the plurality of RFID antenna(s) detected the tag;

(c) comparing the data detected at the first time point and the second time point; and

(d) and determining a relative direction of travel for a tagged object, in relation to the portal.

In an alternate aspect of the inventive subject matter, the portal comprises a at least two RFID antennas which are oriented to read substantially perpendicular to each other in relation to a vertical axis, and are oriented so that each RFID antenna is oriented to read at an angle of about 45 degrees to a direction of travel through the portal.

### EXAMPLES

The following examples are illustrative of the inventive subject matter and are not intended to be limitations thereon.

### Example 1

### Production of an RFID Triangle Reader Apparatus

The inventive apparatus can optionally be constructed as a completely new apparatus, or assembled from existing, off-the-shelf components. The following example illustrates the production of a preferred RFID triangle reader apparatus according to the inventive subject matter. An economical system is an assembly comprising two DC600 RFID units manufactured by Symbol. Such units include an RFID reader, a high-performance antenna, and an integrated electronics module and cabling.

The DC600 units are mounted in a column-shaped structure in the shape of an isosceles triangle, and having a base, a frame, and a plurality of RF-transparent side cover panels coupled to the frame. The angle opposite the longest side of the triangle is preferably about 90 degrees. The reader panels are incorporated into the equal-length sides of the column-shaped structure, and an RF-transparent side cover panels coupled to the frame is installed to cover each side having a DC600 unit incorporated therein. Remaining sides, without incorporated RFID units, may optionally be covered with an RF-transparent side cover panel or an RF-opaque side cover panel. The latter may reduce interference.

### DC600 Specifications

Physical characteristics

| | |
|---|---|
| Dimensions: | Dual and single: |
| | Frame: 14.93″ W × 8.84″ D × 76.66″ (37.92 cm W × 22.45 cm |
| | D × 194.7 cm H) (with Cable Entry Module) |
| | Base: 21″ W × 10.87″ D × 2″ H (53.34 cm W × 27.6 cm D × 5.08 cm |
| | H) |
| | Slim single: |
| | Frame: 14.43″ W × 4.71″ D × 75.76″ (36.65 cm W × 11.96 cm |
| | D × 192.43 cm H) (with Cable Entry Module) |
| | Base: 17.25″ W × 4.75″ D × 1.13″ H (43.8 cm W × 12 cm D × 2.87 cm |
| | H) |
| Weight: | Dual: 112 lbs. (50.8 kg) |
| | Single: 100 lbs. (45.36 kg) |
| | Slim single: 71 lbs. (32.2 kg) |

Electrical

| | |
|---|---|
| Maximum Power | 100-240 volts AC, 50/60 Hz, 2.6 amps |
| Input: | |

Connectivity

| | | |
|---|---|---|
| Network: | 10/100 BaseT Ethernet | RJ45 |
| | RS232 Serial | DB9 |
| Devices: | Control I/O port (12) (user programmable) | DB15 |
| RF connectors: | Reverse TNC | |
| Read points: | 4 Read Points (4 Transmit Points, 4 Receive Points) | |
| Power supply: | +24 v DC @ 1.2 amps | |

Compliance

| | |
|---|---|
| Safety: | UL 60950-1/CSA 60950-1 and IEC60950-1 CB |
| Regulatory: | FCC Part 15 US/IC RSS210 |

Hardware/OS and F/W mgmt.

| | |
|---|---|
| Memory: | Flash 64 MB; DRAM 64 MB |
| Operating system: | Win ® CE (Version 4.2.0) |
| Firmware upgrade: | Web-based and remote firmware upgrade capabilities |

Optional features

| | |
|---|---|
| Frequency: | UHF band, 902-928 MHz US |
| Method: | Frequency Hopping Spread Spectrum (FHSS) |
| Power output: | 4 W EIRP |
| Tag Protocol | EPC ™ Gen 1 (Class 0 read only, Class 0 read/write, Class 1) |
| | and Gen 2 |
| Synchronization: | Network Time Protoco |
| IP addressing: | Static and dynamic |
| Host Interface | XML and Byte Stream |
| Protocols: | |

Environmental

| | |
|---|---|
| Humidity: | 5-95% RH |
| Operating | −20° to 50° C. (−4° to 122° F.) |
| Temperature Range: | |
| Storage Temperature | −40° to 80° C. (−40° to 176° F.) |
| Range: | |

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the inventive subject matter described herein.

We claim:

1. A portal apparatus for tracking a moving object tagged with an RFID tag having a GUID or other identifying number, comprising the following elements operably connected:
(i) a generally column-shaped structure comprising a base and a frame supported by the base, the frame extending along a generally vertical axis of the structure,
wherein the column-shaped structure has three sides and, as viewed from above or below, is substantially in the shape of an isosceles right triangle which defines the three sides of the column-shaped structure: a hypotenuse side opposite the right angle and first and second equal-length leg sides;
(ii) a plurality of RFID antennas which are oriented to read outwardly, are supported by and attached to the frame, are mounted substantially parallel to the first and second equal-length leg sides of the column-shaped structure, and are oriented to read substantially perpendicular to each other in relation to the vertical axis; and
(iii) a reader which is capable of detecting and outputting data received from the plurality of RFID antennas, said data comprising the tag GUID or other identifying number detected and which of the plurality of RFID antennas detected the tag.

2. The apparatus of claim 1, further comprising a plurality of RF-transparent side cover panels coupled to the frame and covering the RFID antennas.

3. The apparatus of claim 1, further comprising a timer, and wherein the apparatus is additionally capable of detecting and outputting a time of detection of a tag.

4. The apparatus of claim 3, additionally comprising a processor and memory, which is capable of receiving, storing and comparing the output antenna, tag number, and time data detected, and determining a relative direction of travel for a tagged object, in relation to the portal.

5. The apparatus of claim 1, wherein the column-shaped structure additionally comprises a fourth side and, as viewed from above or below, is substantially in the shape of a diamond which defines four substantially equal sides of the column-shaped structure, and
wherein the plurality of RFID antennas are mounted substantially parallel to each of the four sides of the column-shaped structure, and are oriented to read outwardly.

6. A portal system for tracking a moving object tagged with an RFID tag having a GUID or other identifying number, comprising the following elements operably connected:
(i) at least two generally column-shaped structures, each comprising a base and a frame supported by the base, the frame extending along a generally vertical axis of the structure,
wherein each column-shaped structure has three sides and, as viewed from above or below, is substantially in the shape of an isosceles right triangle which defines the three sides of the column-shaped structure: a hypotenuse side opposite the right angle and first and second equal-length leg sides;
(ii) a plurality of RFID antennas which are oriented to read outwardly, are supported by and attached to the frame, are mounted substantially parallel to the first and second equal-length leg sides of each column-shaped structure, and are oriented to read substantially perpendicular to each other in relation to the vertical axis,
wherein the at least two generally column-shaped structures are situated on opposite sides of the portal, and are oriented so that each RFID antenna is oriented to read at an angle of about 45 degrees to a direction of travel through the portal;
(iii) a reader which is capable of detecting and outputting data received from the plurality of RFID antennas, said data comprising (a) the tag GUID or other identifying number detected and (b) which of the plurality of RFID antenna(s) detected the tag;
(iv) a timer which is capable of recording and outputting a time of detection of a tag; and
(v) a processor and memory, which is capable of receiving, storing and comparing the output antenna, tag number, and time data detected, and determining a relative direction of travel for a tagged object, in relation to the portal.

7. The system of claim 6, further comprising a plurality of RF-transparent side cover panels coupled to the frame and covering the RFID antennas.

8. The system of claim 6, wherein one or more of the column-shaped structures additionally comprises a fourth side and, as viewed from above or below, is substantially diamond-shaped and defines four substantially equal sides of the column-shaped structure,
wherein the plurality of RFID antennas are mounted substantially parallel to each of the four sides of the column-shaped structure, are oriented to read substantially perpendicular to each other in relation to the vertical axis, and are oriented to read outwardly, and
wherein such diamond-shaped structure(s) are situated between two portals and detect RFID tags in motion through each portal.

9. A method for tracking an object, tagged with an RFID tag, passing through a portal, comprising the steps of:
(a) at a first time point, recording, date stamping, and storing in a database data received from a plurality of RFID antennas, said data comprising (i) a tag GUID or other identifying number detected and (ii) which of the plurality of RFID antenna(s) detected the tag;
(b) at a second time point, recording, date stamping, and storing in a database data received from a plurality of RFID antennas, said data comprising (i) a tag GUID or other identifying number detected and (ii) which of the plurality of RFID antenna(s) detected the tag;
(c) comparing the data detected at the first time point and the second time point; and
(d) and determining a relative direction of travel for a tagged object, in relation to the portal.

10. The method of claim 9, wherein the portal comprises a at least two RFID antennas which are oriented to read substantially perpendicular to each other in relation to a vertical axis, and are oriented so that each RFID antenna is oriented to read at an angle of about 45 degrees to a direction of travel through the portal.
